(19) United States
(12) Patent Application Publication
(10) Pub. No.: US 2023/0256621 A1
(43) Pub. Date: Aug. 17, 2023

(54) ROBOT HAND AND ROBOT

(71) Applicant: SAMSUNG ELECTRONICS CO., LTD., Suwon-si (KR)

(72) Inventors: Takeshi YAMAGISHI, Yokohama-shi (JP); Yuki ABE, Yokohama-shi (JP)

(73) Assignee: SAMSUNG ELECTRONICS CO., LTD., Suwon-si (KR)

(21) Appl. No.: 18/095,068

(22) Filed: Jan. 10, 2023

Related U.S. Application Data
(63) Continuation of application No. PCT/KR22/18452, filed on Nov. 22, 2022.

(30) Foreign Application Priority Data
Feb. 15, 2022 (JP) 2022-021024

(51) Int. Cl. B25J 15/02; B25J 15/04; B25J 19/00; B25J 19/02; B25J 9/16

(52) U.S. Cl. CPC B25J 15/0273; B25J 15/028; B25J 15/0441; B25J 19/0075; B25J 19/023; B25J 9/1697

(57) ABSTRACT

Provided are a robot hand which may be detached by a simpler mechanism, and a robot including the robot hand. The robot hand includes: a gripping part configured to grip a target object; and a mounting part configured to mount the gripping part to a mounted part of a robot, wherein the gripping part may be further configured to operate in a first movement region to grip the target object, and a second movement region to be removed from the mounted part, and wherein the mounting part is engaged with the mounted part in the first movement region, and the mounting part is removed from the mounted part in the second movement region.

### CROSS-REFERENCE TO RELATED APPLICATION

This application is a continuation of International Application No. PCT/KR2022/018452 designating the United States, filed on Nov. 22, 2022, in the Korean Intellectual Property Receiving Office and claiming priority to Japanese Patent Application No. 2022-021024, filed on Feb. 15, 2022, the disclosures of which are incorporated by reference herein in their entireties.

### BACKGROUND

### 1. Field

Apparatuses and methods consistent with the disclosure relate to a robot hand and a robot, and more particularly, to a replaceable robot hand and a robot including the robot hand.

### 2. Description of the Related Art

In recent years, attempts have been made to develop a robot which is capable of grasping a tool normally used by a human and performing various tasks with the tool. Here, the robot may replace a robot hand, which is a part that grips the tool or the like, with a different hand to respond to the various tasks. For example, a robot may replace one hand for another that is better suited to perform cleaning functions, such as a hand that includes a cleaning nozzle. The robot hand is being introduced in some markets, such as for industrial use or research and development.

In the related art, a replaceable robot hand includes an actuator or the like as a mechanism for detachment of the robot hand. For this reason, the structure of such a robot hand may be complicated, and the number of its parts may become easily increased. As a result, the robot hand may tend to be expensive. Moreover, the robot hand may tend to become large in size and heavy in weight. It is thus difficult to introduce the robot hand, for example, for home use.

In the related art, a replaceable robot hand includes an actuator or the like as a mechanism for detachment of the robot hand. For this reason, the structure of such a robot hand may be complicated, and the number of its parts may become easily increased. As a result, the robot hand may tend to be expensive. Moreover, the robot hand may tend to become large in size and heavy in weight. It is thus difficult to introduce the robot hand, for example, for home use.

### SUMMARY

Provided are a robot hand which may be detached by a simpler mechanism, and a robot including the robot hand.

According to an aspect of the disclosure, a robot hand includes: a gripping part configured to grip a target object; and a mounting part configured to mount the gripping part to a mounted part of a robot, wherein the gripping part may be further configured to operate in a first movement region to grip the target object, and a second movement region to be removed from the mounted part, and wherein the mounting part is engaged with the mounted part in the first movement region, and the mounting part is removed from the mounted part in the second movement region.

The mounting part may include a slide part configured to slide in conjunction with an operation of the gripping part, and the mounting part may be engaged with the mounted part by engaging the slide part to the mounted part in the first movement region as the slide part slides, and the mounting part may be removed from the mounted part by disengaging the slide part from the mounted part in the second movement region.

The mounting part may include a cam configured to rotate in conjunction with the operation of the gripping part, and the slide part slides by a force transmitted to the slide part by the cam.

The mounting part may include a link part that is connected to the slide part, the slide part may be configured to be operated in conjunction with the operation of the gripping part, and the slide part may simultaneously slide by a force transmitted through the link part.

The robot hand may further include a waterproof cover that covers an exterior of the robot hand.

The gripping part may include a joint part and a non-joint part, and the waterproof cover may include a first cover that covers the joint part, and a second cover that covers the non-joint part.

The robot hand may further include a packaging part configured to waterproof seal a boundary between the first cover and the second cover.

The second cover may be operable to be deformed when the joint part moves.

The robot hand may further include a transmission part that includes a magnetic coupling mechanism, and the transmission part may be configured to transmit a driving force of a motor to the gripping part through the magnetic coupling mechanism, and disengage the gripping part from the mounted part by causing the gripping part to operate in the second movement region.

The magnetic coupling mechanism may include a first magnetic rotation part and a second magnetic rotation part, the magnetic coupling mechanism may be configured to transmit the driving force of the motor by connecting the first magnetic rotation part provided on the mounted part with the second magnetic rotation part provided on the transmission part, and the waterproof cover may be provided between the first magnetic rotation part and the second magnetic rotation part.

The robot hand may further include an adhesion part configured to adhere to the target object.

The gripping part may include a pair of hands, and wherein the adhesion part may be provided on at least one of: one hand of the pair of hands and a portion of the gripping part located between the pair of hands.

The adhesion part may be provided on a front end of one hand of the pair of hands, and a front end of the other hand of the pair of hands does not include an adhesion part.

A plurality of adhesion parts are provided on the front end of the one hand of the pair of hands.

The adhesion part may include: an adhesion pad configured to adhere to the target object; a pump configured to suction air into the robot hand, and a first waterproof filter configured to filter water from the air suctioned into the robot hand by the pump.

The adhesion part may include an exhaust port, the exhaust port may include a second waterproof filter, and the exhaust port may be configured to exhaust the air suctioned into the robot hand by the pump and prevent water from entering the inside of the robot hand through the exhaust port.

The robot hand may further include a film covering at least a portion of the adhesion pad.

The robot hand may further include a pressing mechanism provided on a surface of the adhesion pad, opposite to a surface on which the adhesion pad adheres to the target object, and configured to press the adhesion pad.

According to an aspect of the disclosure, a robot includes: a gripping part configured to grip a target object; a mounted part; and a mounting part configured to mount the gripping part to the mounted part, wherein the gripping part is configured to operate in a first movement region to grip the target object, and a second movement region to be removed from the mounted part, and wherein the mounting part is engaged with the mounted part in the first movement region, and the mounting part is removed from the mounted part in the second movement region.

According to an aspect of the disclosure, a robot includes: a gripping part configured to grip a target object; a mounted part configured to mount the gripping part thereto; a motor configured to drive the gripping part; and a controller configured to control the motor, wherein the gripping part may be further configured operate in a first movement region and a second movement region, and wherein the controller may be further configured to control the gripping part to operate in the first movement region to grip the target object and operate in the second movement region to be removed from the mounted part.

The robot may further an adhesion part, and the controller may be further configured to further control the adhesion part to adhere to the target object.

The controller may be further configured to simultaneously control the gripping part to grip the target object and control the adhesion part to adhere to the target object.

The robot may further include an imaging device, and the controller may be further configured to: obtain an image of the target object using the imaging device, identify whether the target object is a registered target object or an unregistered target object based on the image, and based on identifying the target object is the registered target object, control at least one of gripping the target object by the gripping part using a method registered for the target object, or adhering to the target object by the adhesion part using a method registered for the target object.

The controller may be further configured to, based on identifying the target object is the unregistered target object, control at least one of gripping the target object by the gripping part, adhering to the target object by the adhesion part, or registering at least one method in which the unregistered target object is successfully gripped or adhered.

The gripping part may include a pair of hands, and the adhesion part is provided on at least one of one hand of the pair of hands or a portion of the gripping part located between the pair of hands.

The adhesion part may include: an adhesion pad configured to adhere to the target object; a pump configured to suction air into the robot; and a first waterproof filter configured to filter water from the air suctioned into the robot by the pump, and the controller may be further configured to control the adhesion pad to adhere to the target object by controlling an operation of the pump.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows an example of an overall configuration of a robot system according to embodiments of the disclosure;

FIGS. 2A and 2B are views of a first example of a mechanism for a detachable robot hand according to an embodiment;

FIGS. 3A and 3B are views showing the first example of the mechanism for the detachment of the robot hand according to an embodiment;

FIG. 4 is a view showing the first example of the mechanism for the detachment of the robot hand according to an embodiment;

FIGS. 5A and 5B are views showing a second example of the mechanism for the detachment of the robot hand according to an embodiment;

FIGS. 6A and 6B are views showing the second example of the mechanism for the detachment of the robot hand according to an embodiment;

FIG. 7 is a view showing the second example of the mechanism for the detachment of the robot hand according to an embodiment;

FIGS. 8A and 8B are views showing a case where a mounting part is a rack-and-pinion type mounting part according to an embodiment;

FIGS. 9A and 9B are views each showing a case where the mounting part is a lead screw according to an embodiment;

FIG. 10A shows a state where a motor is removed together with a hand part without leaving the motor on an arm, and FIG. 10B shows a state where the motor is left on the arm and the hand part is removed according to an embodiment;

FIGS. 11A and 11B are views of a waterproofing mechanism of the robot hand according to an embodiment;

FIG. 12 shows a packaging part according to an embodiment;

FIG. 13 is a view showing a magnetic coupling mechanism according to an embodiment;

FIG. 14 is a view showing the magnetic coupling mechanism according to an embodiment;

FIG. 15 is a view showing a cross-sectional structure of the hand according to an embodiment;

FIGS. 16A and 16B are enlarged cross-sectional views of adhesion parts according to an embodiment;

FIG. 17 is a perspective view of a robot hand according to an embodiment;

FIGS. 18A, 18B and 18C are side, cross-sectional views showing an operation of the adhesion part in an embodiment of the disclosure.

FIGS. 19A and 19B are side, cross-sectional views showing an operation of the adhesion part in an alternative embodiment of the disclosure.

FIG. 20 is a flowchart of a method for controlling a robot according to an embodiment.

### DETAILED DESCRIPTION

Hereinafter, embodiments of the disclosure are described in detail. However, the disclosure is not limited to the following embodiments. Further, the embodiments may be variously modified within the scope of the gist. Furthermore, the drawings used here are provided for explaining the embodiments of the disclosure rather than representing the actual sizes.

Hereinafter, embodiments of the disclosure are described in detail with reference to the accompanying drawings.

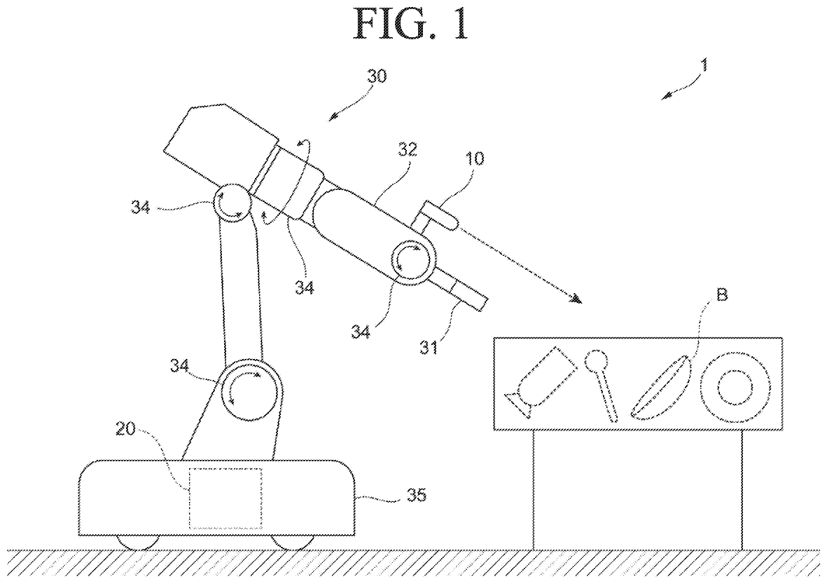

FIG. 1 is a view showing an example of an overall configuration of a robot 1 according to embodiments of the disclosure.

The robot 1 shown in the drawing may include an imaging device 10, a control device 20 and a robot body 30. In addition, FIG. 1 shows a plurality of target objects B which are not part of robot 1. The target objects B are objects to be gripped by the robot body 30. FIG. 1 shows an exemplary case where robot 1 washes dishes (target objects B) or the like. In this example, the target objects B may be the tableware or the like, and specifically, the target object B may be a plate, a cup, a bowl, a spoon or the like. In addition, the target objects B may be a detergent, a dish sponge or the like used to wash the dishes. In addition, the robot body 30 may grip these target objects and perform the washing of the dishes or the like.

The imaging device 10 may capture an image of the target objects B. The imaging device 10 may be, for example, a camera. In an embodiment, the imaging device 10 may be mounted on a front end of the robot body 30. In another embodiment, the imaging device 10 may capture the target objects B from above and generate a captured image.

The control device 20 may request the position and posture of the target objects B based on the image captured by the imaging device 10. Moreover, the control device 20 may control an operation of the robot body 30.

The robot body 30 may perform gripping of the target objects B. The robot body 30 may include a robot hand 31 that actually performs the gripping of the target objects B, and an arm 32 that performs positioning of the robot hand 31. In addition, the robot body 30 may include one or more actuators 34 that performs a rotation operation under control of the control device 20. In addition, the robot body 30 in the embodiments of the disclosure may include a movable and self-propelled moving part 35.

In an embodiment, the robot 1 described above may be operated as follows. First, the imaging device 10 may capture the image of the target objects B. This captured image may be obtained under the control of the control device 20. In addition, the control device 20 may request the type, position and posture of the target objects B based on the captured image. The type of the target objects B may be, for example, one or more of a plate, cup, bowl, spoon or the like as mentioned above. The position and posture of the target objects B may be the position of the target objects B in a three-dimensional space and their respective posture taken in the three-dimensional space. In addition, the control device 20 may control the robot hand 31 and the arm 32 based on the type, position and posture of the target objects B, and control the gripping of the target objects B. The robot body 30 may be rotated by the actuators 34 in multiple directions as indicated by the rotational arrows as shown in FIG. 1. In addition, the robot hand 31 and the arm 32 may be moved to their positions for gripping the target objects B by rotating the actuators 34. For example, the robot body 30 may perform washing of a target object B after the target object B is gripped. The robot body 30 may then wash the target object B by itself. Alternatively, the robot body 30 may put the target object B in a washing machine such as a dishwasher, and the washing machine may perform actual washing.

In an embodiment, the robot 1 is not limited to perform the washing of a target object B. For example, the robot 1 may be a cleaning robot that performs cleaning. Alternatively, the robot 1 may be an assembly robot that performs assembling of parts with each other. Alternatively, the robot 1 may be a welding robot that performs welding. Alternatively, for example, the robot 1 may be a transport robot that performs transporting or a painting robot that performs painting. In addition, the robot hand 31 in the embodiments of the disclosure may be detached, and thus be replaced, which is described below in detail. The robot 1 may thus be used for various purposes beyond the washing of a target object B by replacing the robot hand 31.

In addition, the robot 1 may be a mobile robot that is moved frequently or a stationary robot that is fixed in a predetermined place.

In an embodiment, robot hand 31 may be detachable. In a first embodiment, robot hand 31 may be detached from the arm using a cam mechanism. Here, the robot hand 31 in a normal usage state may be fixed (or locked) to the arm 32 by the cam mechanism. In addition, the robot hand 31 may be released (or the robot hand 31 may be unlocked) from arm 32 by the cam mechanism, and thus be removed from the arm 32. Therefore, the robot hand 31 may be replaced. Here, the ‘normal usage state’ may refer to a state where robot hand 31 is being used for a given purpose, for example to grip a target object B and perform an operation such as the cleaning.

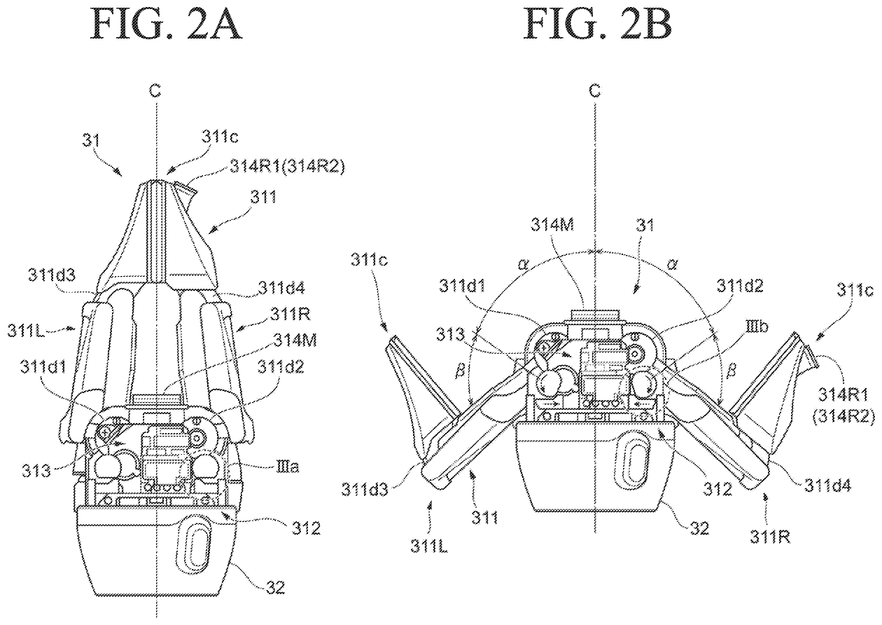

FIGS. 2A, 2B, 3A, 3B and 4 are views showing the first example of the mechanism for the detachment of the robot hand 31 according to an embodiment.

FIGS. 2A and 2B each show the robot hand 31 mounted on the arm 32. FIG. 2A shows the normal usage state of the robot hand 31. In this state, the robot hand 31 may be fixed (or locked) to the arm 32. FIG. 2B shows the robot hand 31 is configured to be detached from the arm 32. In this state, the robot hand 31 may be removed from the arm 32.

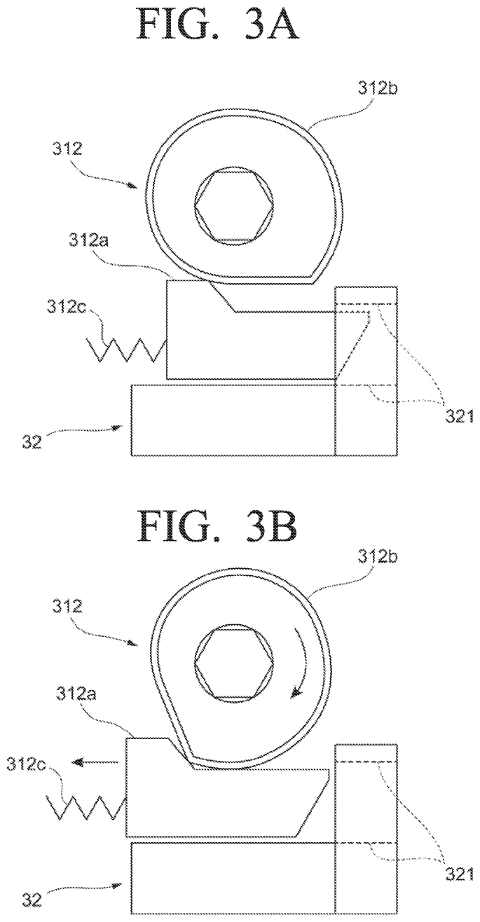

FIG. 3A is an enlarged view of subassembly Ma of FIG. 2A where robot hand 31 is locked to arm 32. In addition, FIG. 3B is an enlarged view subassembly Mb of FIG. 2B where robot hand 31 may be detached from arm 32.

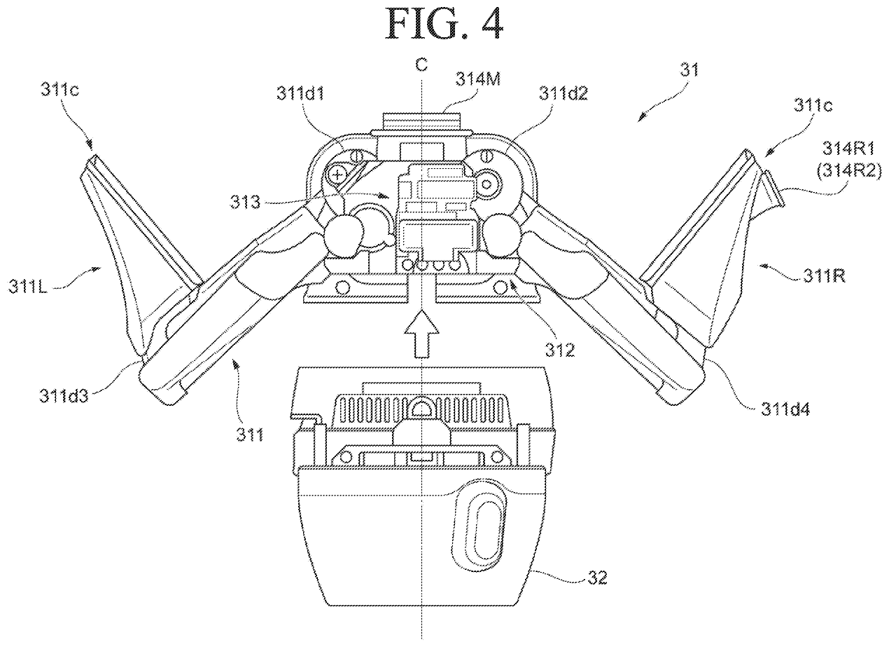

FIG. 4 shows robot hand 31 removed from the arm. That is, FIG. 4 is a view showing a state where the robot hand 31 is separated from the arm 32.

As shown in FIGS. 2A and 2B, the robot hand 31 may include a hand part 311, a mounting part 312, a speed reducer 313, an adhesion part 314R1 or 314R2 and an adhesion part 314M. In addition, FIGS. 2A and 2B also partially show a member of the arm 32 although the member is not included in the robot hand 31.

In an embodiment, the hand part 311 may be a gripping part and may be driven by a motor and grip a target object B. In this case, the hand part 311 may include a hand 311L and a hand 311R. The hand 311L and the hand 311R may be a pair of members. The hand 311L and the hand 311R may grip a target object B at front ends 311c thereof. In other words, the hand 311L and the hand 311R may hold the target object B. The hand 311L and the hand 311R may each include joint parts 311d1 to 311d4. The joint parts 311d1 to 311d4 may respectively be rotated in conjunction with each other. As a result, a distance between the hand 311L and the hand 311R may be changed at parts of the front ends 311c. In addition, the target object B may then be gripped by the hand 311L and the hand 311R by fitting the target object B to the front ends 311c thereof. It is then possible to move the target object B gripped by the hand 311L and the hand 311R.

The hand part 311 may have a first movement region used in case of gripping the target object B. The hand part 311 may also have a second movement region used in case of removing the hand part 311 from a mounted part. The mounted part may be an object to which the hand part 311 is mounted, for example, the arm 32.

FIG. 2B shows the first movement region and the second movement region. Here, a center line C may refer to a vertical direction from a portion where the hand 311L and the hand 311R are in contact with each other on the front ends 311c and this angle may be zero degrees. Here, the first movement region of the hand 311L may be in a range of zero degrees or more and alpha (a) degrees or less in a left rotation direction. In addition, the first movement region of the hand 311R may be in a range of zero degrees or more and a degrees or less in a right rotation direction. In addition, the second movement region of the hand 311L may be in the range of a degrees or more and (α+β) degrees or less in the left rotation direction. In addition, the second movement region of the hand 311R may be in the range of a degrees or more and (α+β) degrees or less in the right rotation direction. Here, the vertical direction, the left direction and the right direction are the directions shown in the drawings, and the hand part 311 may not be actually operated in such a direction.

The mounting part 312 may mount the hand part 311 to the mounted part. In this case, the mounted part may be the object to which the hand part 311 is mounted, and be the arm 32. That is, the mounting part 312 may be a mechanism for mounting the hand part 311 to the arm 32.

In an embodiment, the mounting part 312 may be fixed to the arm 32 in the first movement region. The mounting part 312 may be removed from the arm 32 in the second movement region. In addition, the mounting part 312 may be removed from the arm 32 in the second movement region, i.e., in any portion within the second movement region. For example, the mounting part 312 may be removed from the arm 32 when the hand 311L is moved at (α+β) degrees in the left rotation direction of the joint portion 311d1. Alternatively, the mounting part 312 may be removed from the arm 32 when the hand 311R is moved at (α+β) degrees in the right rotational direction of the joint portion 311d2. That is, in case that the hand 311L and the hand 311R are fully opened, the mounting part 312 may be removed from the arm 32.

FIGS. 3A and 3B show enlarged views of an embodiment of mounting part 312.

The mounting part 312 may include a slide part 312a that slides in conjunction with an operation of the hand part 311. The mounting part 312 may further include a cam 312b that is rotated in conjunction with the operation of the hand part 311. The mounting part 312 may further include a press part 312c that presses the slide part 312a. The press part 312c may be, for example, a coil spring.

FIG. 3A shows a position of mounting part 312 where the mounting part 312 is fixed to the arm 32. Here, the hand part 311 may be in the first movement region. In addition, the cam 312b may be in its rotated position shown in FIG. 3A, and may not be engaged with the slide part 312a. Here, the slide part 312a may be pressed by the press part 312c in the toward hole part 321 of arm 32 and enters hole part 321. As a result, the slide part 312a and the hole part 321 may be fitted to each other. Accordingly, the mounting part 312 may be fixed to the arm 32, and the robot hand 31 may thus be fixed to the arm 32.

On the other hand, FIG. 3B shows a state where the mounting part 312 is disengaged from arm 32. Here, the hand part 311 may be in the second movement region. In addition, the cam 312b may turn clockwise from the state shown in FIG. 3A to arrive in its rotated position shown in FIG. 3B. The cam 312b may be engaged with the slide part 312a. Here, the slide part 312a may be pressed by a force transmitted to the slide part 312a through the cam 312b in the left direction in the drawing. The slide part 312a may slide in the left direction in the drawing. The slide part 312a may thus be moved to its position where the slide part 312a does not enter the hole part 321 of the arm 32. As a result, the fitting of the slide part 312a and the hole part 321 may be released from each other. Accordingly, the mounting part 312 may be removed from the arm 32, and the robot hand 31 may thus be removed from the arm 32.

In an embodiment, the slide part 312a may be fit into the hole part 321 of the arm 32 in the first movement region as the slide part 312a slides. The mounting part 312 may thus be fixed to the arm 32. As a result, the robot hand 31 may be fixed to the arm 32.

Conversely, the fitting of the slide part 312a may be released from the arm 32 in the second movement region. The mounting part 312 may thus be removed from the arm 32. As a result, the robot hand 31 may be removed from the arm 32. The robot hand 31 may thus be separated from the arm 32 as shown in FIG. when the mounting part 312 is removed from the arm 32.

In an embodiment, the speed reducer 313 may be a transmission part that transmits a driving force of the motor to the hand part 311. The speed reducer 313 is a device for reducing a rotation number of the motor. The speed reducer 313 may include a gear or the like. The rotation number may be reduced by the speed reducer 313 at a predetermined reduction ratio. In addition, the hand part 311 may be operated by the driving force output from the speed reducer 313.

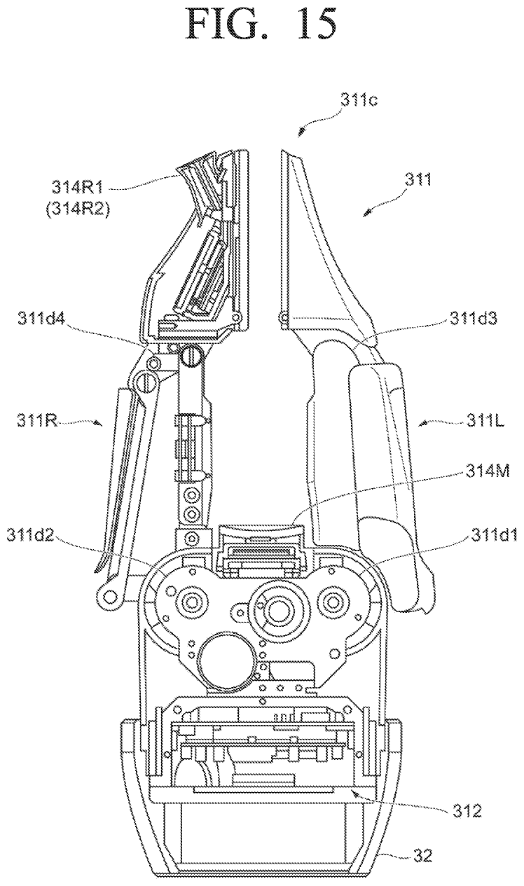

The adhesion part 314R1, 314R2 and the adhesion part 314M may each have a function of adhering to a target object B. The adhesion part 314R1, 314R2 and the adhesion part 314M may each adhere to a target object B by using a negative pressure generated in suctioning air by using a pump. It is thus possible to move the adhered target object B by the hand 311L and the hand 311R. In addition, the adhesion parts 314R1, 314R2 may indicate that the plurality of adhesion parts are the adhesion parts 314R1, 314R2. A specific shape of the adhesion part is described below with reference to FIGS. 15 to 17. In addition, hereinafter, the respective adhesion parts 314R1, 314R2 and 314M may not be distinguished from one another. In this case, the description below may simply describe the corresponding part as an “adhesion part 314.”

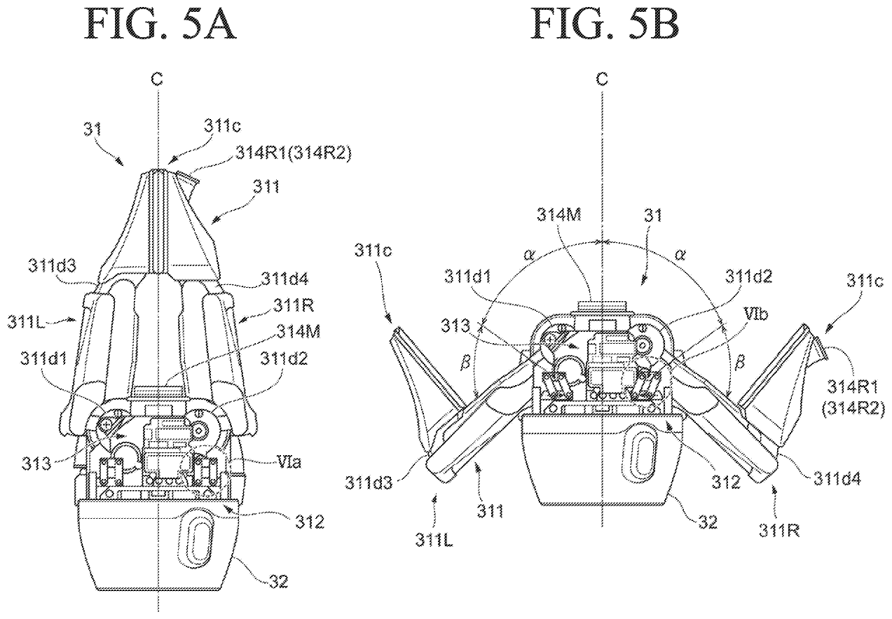

In a second embodiment shown in FIGS. 5A, 5B, 6A, 6B and 7, the robot hand 31 may be detached from the arm using a link mechanism. In this embodiment, the robot hand 31 in the normal usage state may be fixed (or locked) to the arm 32 by the link mechanism. In addition, the lock of the robot hand 31 may be released (or the robot hand 31 may be unlocked) by the link mechanism, and thus be removed from the arm 32.

Among these drawings, FIGS. 5A and 5B each show a state where the robot hand 31 is mounted on the arm 32. FIG. 5A is a view showing the normal usage state of the robot hand 31. FIG. 5B is a view showing a state where the robot hand 31 is configured to be detached from the arm 32.

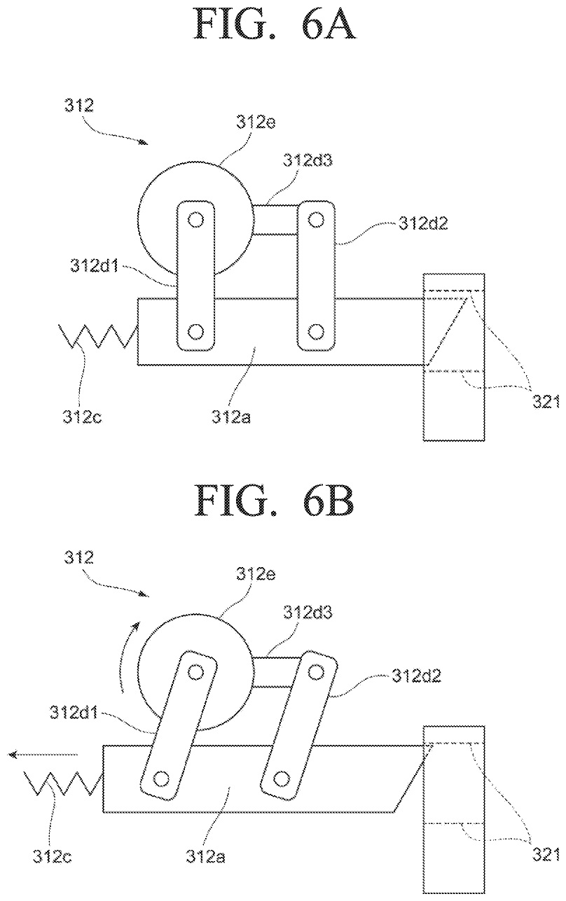

FIG. 6A is an enlarged view of subassembly VIa of FIG. 5A. FIG. 6B is an enlarged view of subassembly VIb of FIG. 5B.

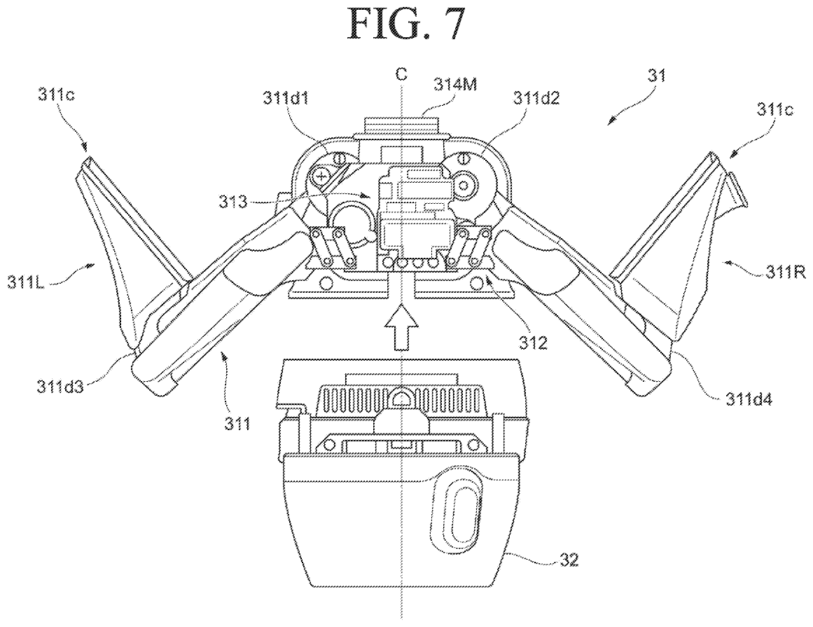

FIG. 7 is a view showing a state where the robot hand 31 is removed from the arm 32.

As shown in FIGS. 5A and 5B, the robot hand 31 may include the hand part 311, the mounting part 312 and the speed reducer 313, as in the previously described embodiment.

The configurations of the hand part 311 and the speed reducer 313 in embodiment of FIGS. 5A and 5B may be the same as the embodiment of FIGS. 2A and 2B. However, a configuration of the mounting part 312 in the embodiment of FIGS. 5A and 5B is different from that of the previously described embodiment.

Referring again to FIGS. 5A and 5B, the mounting part 312 of the second embodiment is described in detail with reference to FIGS. 6A and 6B. FIGS. 6A and 6B are enlarged views of the mounting part 312 of FIGS. 5A and 5B.

Referring to FIGS. 6A and 6B, the mounting part 312 may include the slide part 312a and the press part 312c as in the first example. The slide part 312a may slide in conjunction with the operation of the hand part 311. The press part 312c may press the slide part 312a.

Referring to the embodiment of FIGS. 5A/5B-7, and FIGS. 6A and 6B specifically, the mounting part 312 may include a link part 312d1 connected to the slide part 312a. One end of the link part 312d1 may be rotatable and connected to the slide part 312a. In addition, the other end of the link part 312d1 may not be rotatable, and thus be fixed and connected to the rotation part 312e. The mounting part 312 may further include link parts 312d2 and 312d3. One end of the link part 312d2 may be rotatable and connected to the slide part 312a. In addition, one end of the link part 312d3 may be rotatable and connected to a rotation part 312e. In addition, the other end of the link part 312d2 and the other end of the link part 312d3 may respectively be rotatable and connected with each other.

The rotation part 312e may be rotated in conjunction with the operation of the hand part 311 in a manner similar to the cam 312b of the previously described embodiment. In addition, the slide part 312a may slide by a force transmitted to the slide part 312a through the link parts 312d1 to 312d3 in case that the rotation part 312e is rotated.

FIG. 6A shows a state where the mounting part 312 is fixed to the arm 32. Here, the hand part 311 may be in the first movement region. In addition, the rotation part 312e may be in its rotation position shown in the drawing. Here, the slide part 312a may be biased toward hole part 321 on the right side of the drawing in FIG. 6A by the link parts 312d1 to 312d3 and enter the hole part 321 of the arm 32. As a result, the slide part 312a and the hole part 321 may be fitted to each other. Accordingly, the mounting part 312 may be fixed to the arm 32, and the robot hand 31 may thus be fixed to the arm 32.

On the other hand, FIG. 6B shows a state where the mounting part 312 is removed from the arm 32. Here, the hand part 311 may be in the second movement region. In addition, the rotation part 312e may turn clockwise from the state of FIG. 6A to be in its rotation position shown in the drawing. Here, the slide part 312a may be biased away from hole part 321 (on the left side of the drawing of FIG. 6B) by the force transmitted to the slide part 312a through the link parts 312d1 to 312d3. The slide part 312a may thus slide away from hold part 321 via the force applied by link parts 312d1 to 312d3. The slide part 312a may thus be moved to its position where the slide part 312a does not enter the hole part 321 of the arm 32. As a result, the fitting of the slide part 312a and the hole part 321 may be released from each other. Accordingly, the mounting part 312 may be removed from the arm 32, and the robot hand 31 may thus be removed from the arm 32.

The robot hand 31 may thus be separated from the arm 32 as shown in FIG. 7 as a result of removing the mounting part 312 from the arm 32.

The slide part 312a may slide in the first and second embodiments.

The slide part 312a may be fitted into the hole part 321 of the arm 32 as the slide part slides in the first movement region. The mounting part 312 may thus be fixed to the arm 32. As a result, the robot hand 31 may be fixed to the arm 32.

Meanwhile, the fitting of the slide part 312a may be released from the arm 32 in the second movement region. The mounting part 312 may thus be removed from the arm 32. As a result, the robot hand 31 may be removed from the arm 32.

The mechanism for the detachment of the robot hand 31 is not limited to that of the first or second embodiments. Hereinafter, other examples are described as modified embodiments 1 and 2.

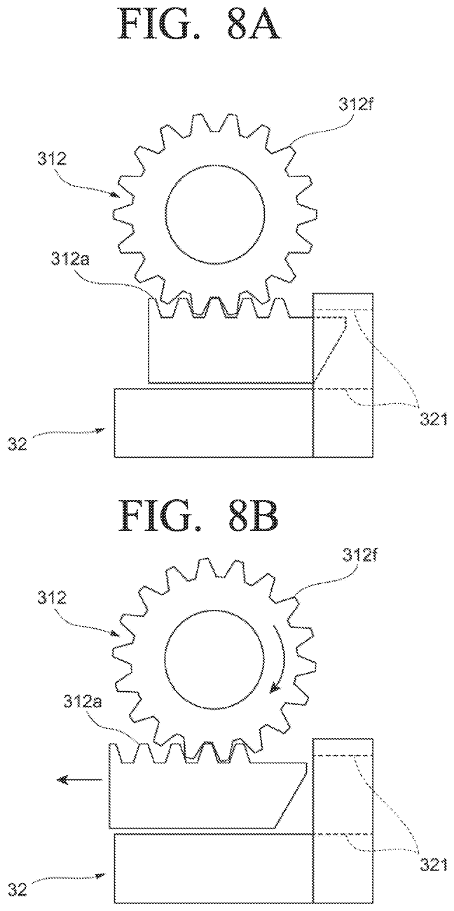

FIGS. 8A and 8B are views each showing an embodiment where the mounting part 312 is a rack-and-pinion type mounting part.

The mounting part 312 may include the slide part 312a as in the first embodiment. The slide part 312a may slide in conjunction with the operation of the hand part 311.

The mounting part 312 may include a pinion 312f. In addition, the slide part 312a may be a rack. The slide part 312a may be assembled with the pinion 312f. In addition, the pinion 312f may be rotated in conjunction with the operation of the hand part 311, similarly to the cam 312b of the first embodiment. In addition, the slide part 312a may slide by a force transmitted to the slide part 312a in case that the pinion 312f is rotated.

FIG. 8A shows a state where the mounting part 312 is fixed to the arm 32. Here, the hand part 311 may be in the first movement region. In addition, the pinion 312f may be in its rotation position shown in the drawing. Here, the slide part 312a may be biased toward hold part 321 (toward the right side of the drawing of FIG. 8A) by the pinion 312f and enter the hole part 321 of the arm 32. As a result, the slide part 312a and the hole part 321 may be fitted to each other. Accordingly, the mounting part 312 may be fixed to the arm 32, and the robot hand 31 may thus be fixed to the arm 32.

On the other hand, FIG. 8B shows a state where the mounting part 312 is configured to be removed from the arm 32. Here, the hand part 311 may be in the second movement region. In addition, the pinion 312f may turn clockwise from the state of FIG. 8A to be in its rotation position shown in FIG. 8B. Here, the slide part 312a may be biased away from hole part 321 (toward the left side of the drawing of FIG. 8B) by the force transmitted to the slide part 312a through the pinion 312f. The slide part 312a may thus slide away from hole part 321 (toward the left side of the drawing of FIG. 8B) via the force applied by the pinion 312f. The slide part 312a may thus be moved to its position where the slide part 312a does not enter the hole part 321 of the arm 32. As a result, the fitting of the slide part 312a and the hole part 321 may be released from each other. Accordingly, the mounting part 312 may be removed from the arm 32, and the robot hand 31 may thus be [symbol] removed from the arm 32.

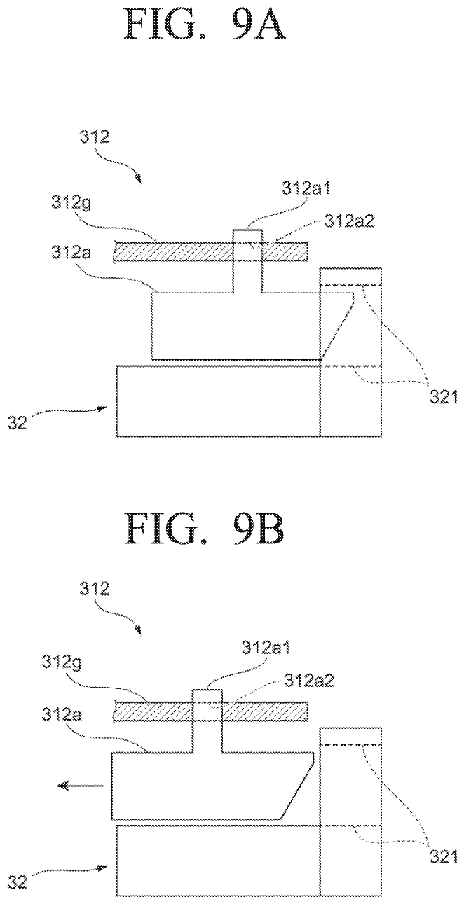

FIGS. 9A and 9B are views each showing an embodiment where the mounting part is a lead screw.

The mounting part 312 may include the slide part 312a as in the first embodiment. The slide part 312a may slide in conjunction with the operation of the hand part 311.

The mounting part 312 may include a lead screw 312g. In addition, the slide part 312a has a protrusion 312a1. The protrusion 312a1 may have a through hole part 312a2 through which the lead screw passes, and a female screw thread formed therein. Meanwhile, the lead screw 312g may have a male screw thread formed thereon. Therefore, slide part 312a may slide by a force transmitted to the slide part 312a when the lead screw 312g is rotated about an axis.

FIG. 9A shows a state where the mounting part 312 is fixed to the arm 32. Here, the hand part 311 may be in the first movement region. In addition, the slide part 312a may here be biased toward hold part 321 (toward the right side of the drawing of FIG. 9A) by the lead screw 312g and enter the hole part 321 of the arm 32. As a result, the slide part 312a and the hole part 321 may be fitted to each other. Accordingly, the mounting part 312 may be fixed to the arm 32, and the robot hand 31 may thus be fixed to the arm 32.

On the other hand, FIG. 9B shows a state where the mounting part 312 is removed from the arm 32. Here, the hand part 311 may be in the second movement region. In addition, the lead screw 312g may be rotated from the state of FIG. 9A. Here, the slide part 312a may be biased away from hold part 321 (toward the left side of the drawing of FIG. 9B) by the force transmitted to the slide part 312a through the lead screw 312g. The slide part 312a may thus slide in the left direction in the drawing by the lead screw 312g. The slide part 312a may thus be moved to its position where the slide part 312a does not enter the hole part 321 of the arm 32. As a result, the fitting of the slide part 312a and the hole part 321 may be released from each other. Accordingly, the mounting part 312 may be removed from the arm 32, and the robot hand 31 may thus be removed from the arm 32.

Additionally or alternatively, a motor 322 may be left on the arm 32, and the hand part 311 may be removed. However, the disclosure is not limited thereto.

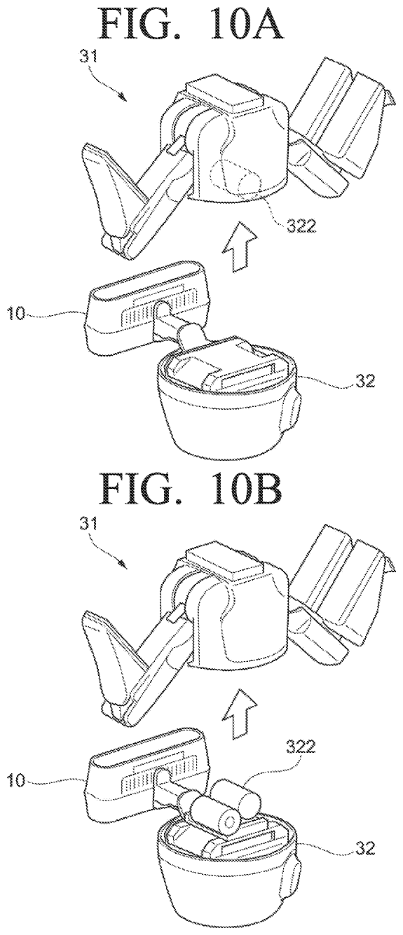

FIG. 10A shows an embodiment where the motor 322 is removed together with the hand part 311 without leaving the motor 332 on the arm 32. In this embodiment, the motor 322 is inside the hand part 311.

FIG. 10B shows an embodiment where the motor 322 is left on the arm 32 and the hand part 311 is removed. In this embodiment, the motor 322 is on the arm 32. In this embodiment, water may not enter the motor 322 or a control board even though the hand part 311 is washed. In addition, it is easy to make the robot hand 31 smaller and lighter. It is also easier to produce the robot hand 31 at a lower cost.

Next, a waterproofing mechanism of the robot hand 31 is described. The robot hand 31 may be washed after being removed. For example, the robot hand 31 used for washing dishes may be put into a dishwasher and washed. Therefore, the description below describes a case where the robot hand 31 includes the waterproofing mechanism.

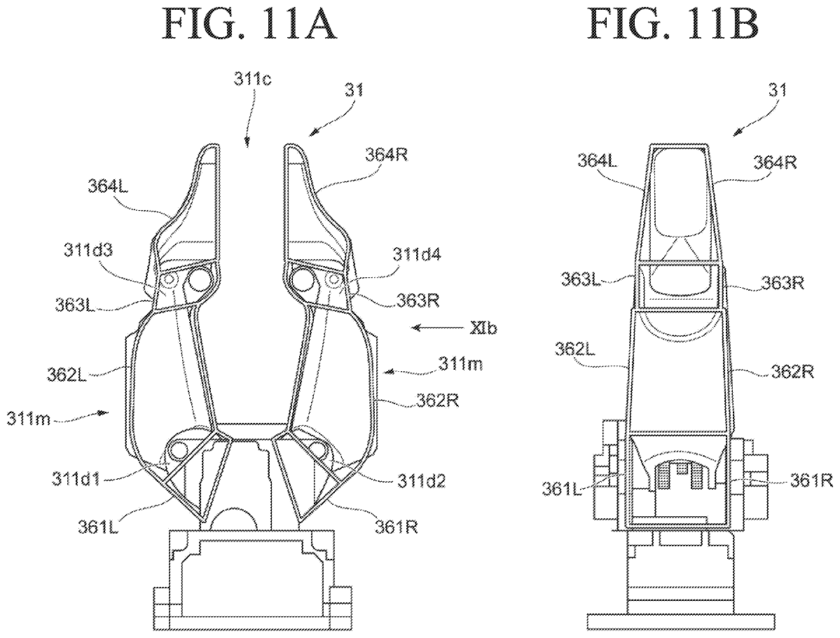

FIGS. 11A and 11B are views of the waterproofing mechanism of the robot hand 31 according to an embodiment. Among these drawings, FIG. 11A is a front view of the robot hand 31. In addition, FIG. 11B is a side view seen from a direction XIb of FIG. 11A.

In this case, the waterproofing mechanism of the robot hand 31 may include waterproof covers 361L to 364L and 361R to 364R. The waterproof covers 361L to 364L and 361R to 364R are an example of a waterproof part that performs waterproofing of the entire outside of the robot hand 31. That is, the entire outside of the robot hand 31 may be covered by the waterproof covers 361L to 364L and 361R to 364R. Accordingly, water may not enter the robot hand 31.

As shown in the drawings, the joint part 311d1 of the hand 311L may be mounted with a waterproof cover 361L. In addition, an intermediate part 311m of the hand 311L may be mounted with the waterproof cover 362L. In addition, the joint part 311d3 of the hand 311L may be mounted with the waterproof cover 363L. In addition, the front end 311c of the hand 311L may be mounted with the waterproof cover 364L.

The joint part 311d2 of the hand 311R may be mounted with the waterproof cover 361R. In addition, an intermediate part 311m of the hand 311R may be mounted with the waterproof cover 362R. In addition, the joint part 311d4 of the hand 311R may be mounted with the waterproof cover 363R. In addition, the front end 311c of the hand 311R may be mounted with the waterproof cover 364R.

In addition, hereinafter, the respective waterproof covers may not be distinguished from one another. In this case, the description may simply describe the corresponding part as a “waterproof cover 36.”

The waterproof covers 361L, 361R, 363L and 363R may be an example of a first cover that covers the joint parts 311d1 to 311d4. The waterproof covers 361L, 361R, 363L and 363R may be flexible covers. That is, the waterproof covers 361L, 361R, 363L and 363R have flexibility. The waterproof covers 361L, 361R, 363L and 363R may thus be deformed based on operations of the joint parts 311d1 to 311d4. The waterproof covers may thus maintain waterproofness of the robot hand without a gap occurring therein even though the joint parts 311d1 to 311d4 are operated.

In addition, the waterproof covers 362L, 362R, 364L and 364R may be an example of a second cover that covers a part other than the joint parts 311d1 to 311d4. The waterproof covers 362L, 362R, 364L and 364R may be rigid covers.

The waterproof cover 36 is not particularly limited to any specific material as long as the waterproof cover 36 blocks water. For example, the waterproof cover 36 may use polyvinyl chloride (PVC), polyester (PEs), a rubber material, etc.

In addition, the waterproofing mechanism of the robot hand 31 may include a packaging part that performs waterproofing of a boundary between the first cover and the second cover. The packaging part may be, for example, an O-ring.

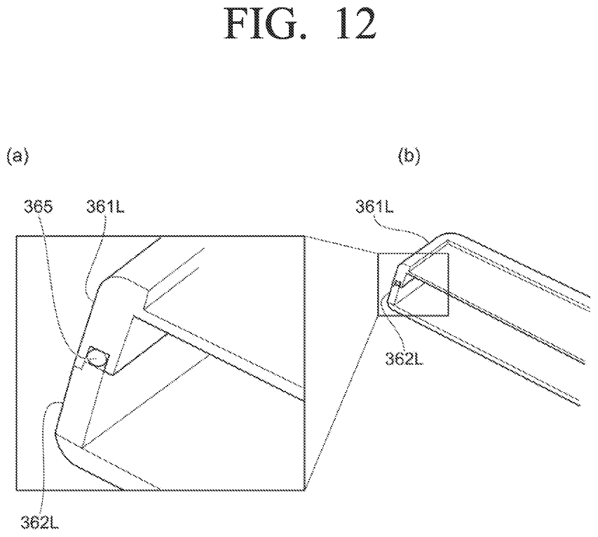

FIG. 12 is a view showing the packaging part according to an embodiment.

For example, the drawings show an O-ring 365 that packages a boundary between the waterproof cover 361L and the waterproof cover 362L. View (b) of FIG. 12 shows the boundary between the waterproof cover 361L and the waterproof cover 362L. In addition, the O-ring 365 may be fitted to this boundary, as shown in view (a) of FIG. 12. The O-ring 365 may prevent the occurrence of the gap between the waterproof covers 36 and maintain the waterproofness.

The waterproofness may be improved by using the waterproof cover 36 or the O-ring 365. In addition, the waterproof cover in this form may have superior design compared to a waterproof cover in the form of gloves. In addition, the waterproof cover 36 may be easily mounted on the robot hand 31.

In addition, a screwing part may also be packaged by the O-ring or the like. For this reason, the screwing part may include no gap occurring therein, and thus maintain its waterproofness.

The waterproof cover 36 may also perform waterproofing of a portion where the robot hand 31 is connected to the arm 32. The waterproof cover 36 may also perform the waterproofing of the boundary between the robot hand 31 and the arm 32.

However, the motor 322 may be positioned on the arm 32 as shown in FIG. 10B. Here, a problem may occur in a mechanism that transmits a driving force of the motor 322 to the robot hand 31. In the embodiments of the disclosure, this problem may be solved by a magnetic coupling mechanism (or magnetic coupling connection).

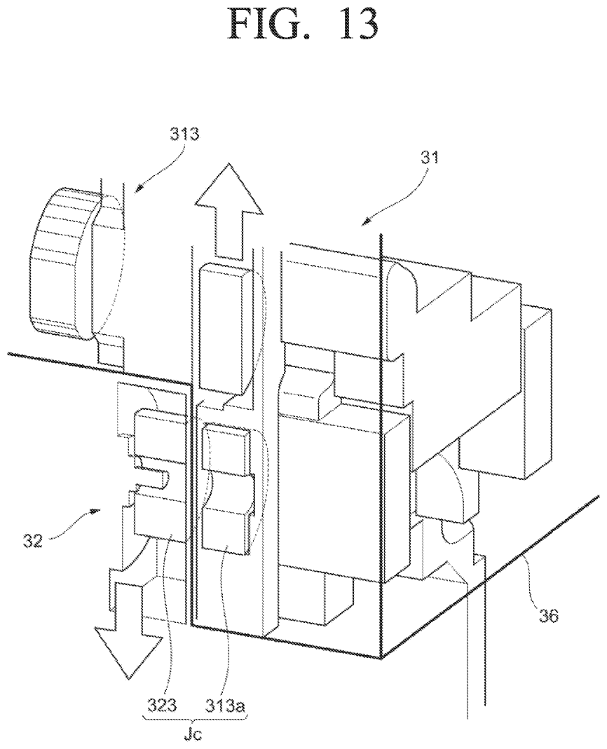

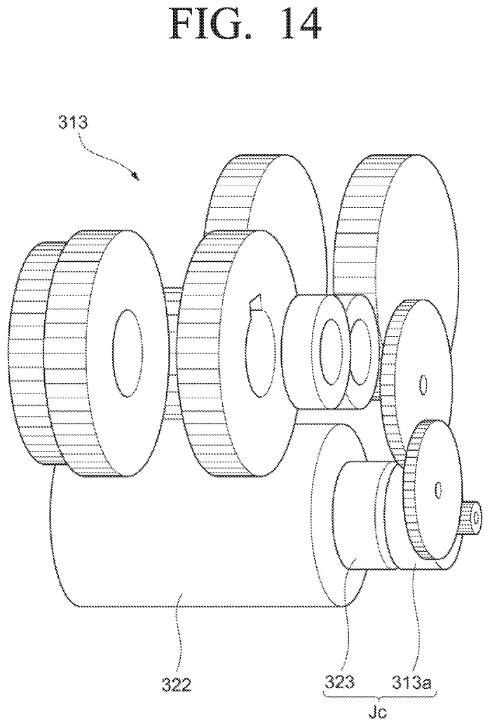

FIGS. 13 and 14 are views each showing the magnetic coupling mechanism according to embodiments of the disclosure.

As described above, the waterproof cover 36 may be positioned on the outside of the robot hand 31. In this case, as shown in FIG. 13, the waterproof cover 36 may be positioned between the robot hand 31 and the arm 32. In addition, the waterproof cover 36 may be inserted between the robot hand 31 and the arm 32, and a magnetic coupling mechanism Jc may be positioned thereon. The magnetic coupling mechanism Jc may include a magnet 323 and a magnet 313a. The magnet 323 may be connected to the motor 322 to be rotated. In addition, the magnet 323 and the magnet 313a may be connected with each other by a magnetic force, and the magnet 313a may be rotated in the same way as the magnet 323. In addition, the magnet 313a may be a part of the speed reducer 313, and the speed reducer 313 may be operated in conjunction with the magnet 313a. That is, the driving force of the motor 322 may be transmitted from the magnet 323, to the magnet 313a and then to the speed reducer 313. As a result, the robot hand 31 may be operated by the driving force of the motor 322. Here, the magnet 323 may be an example of a first magnetic rotation part. In addition, the magnet 313a may be an example of a second magnetic rotation part.

The magnet 323 and the magnet 313a may be connected with each other only by the magnetic force through the waterproof cover 36. It is thus possible to separate the magnet 323 and the magnet 313a from each other by applying a shearing force in the directions indicated by the arrows of FIG. 13. It is thus possible to remove the robot hand 31 by using the magnetic coupling mechanism Jc while maintaining the waterproofness of the robot hand by the waterproof cover 36.

In this case, the speed reducer 313 may transmit the driving force of the motor 322 by using the magnetic coupling mechanism Jc. The robot hand 311 may be removed from the arm 32 by being separated from the magnetic coupling mechanism Jc. In addition, in the magnetic coupling mechanism Jc, the magnet 323 positioned on the arm 32 and the magnet 313a positioned on the speed reducer 313 may be connected with each other by the magnetic force. The driving force of the motor 322 may thus be transmitted. In addition, the waterproof cover 36 may be positioned between the magnet 323 and the magnet 313a.

In addition, the motor 322 may be controlled by the control device 20. In an embodiment, the control device 20 is a controller. For example, a user may input a command to the robot 1 to remove the robot hand 31 by using a control panel or a portable terminal. The control device 20 may thus control the motor 322 and move the hand part 311 from the first movement region to the second movement region, which will then allow the robot hand 31 to be removed.

Next, the adhesion part 314 is described in more detail.

FIGS. 15, 16A, 16B, 17, 18A, 18B, 18C, 19A, 19B and 20 are views of an adhesion part 314 according to an embodiment.

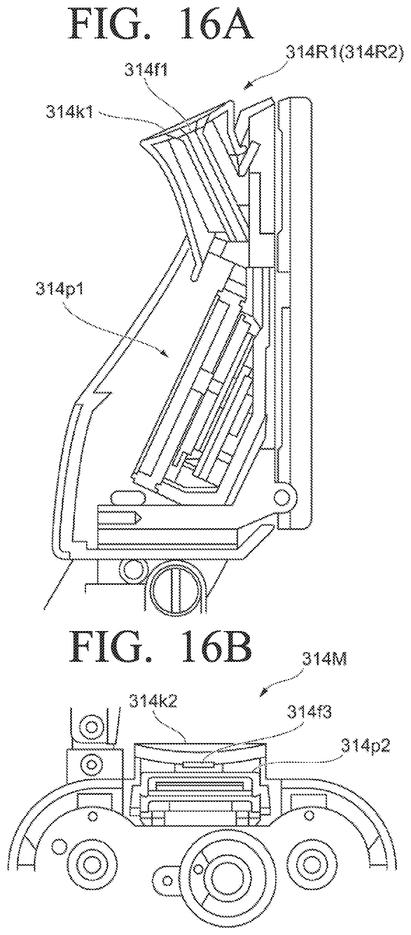

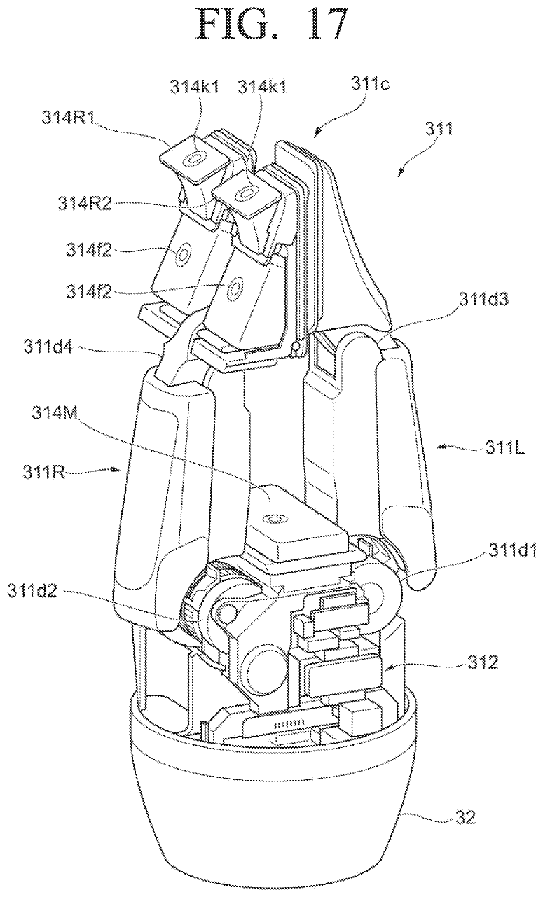

Among these drawings, FIG. 15 is a view showing a cross-sectional structure of the hand 311R (FIG. 15 does not show a cross-sectional structure of the hand 311L). FIG. 16A is an enlarged view of the adhesion part 314R1 or 314R2 shown in FIG. 15, and FIG. 16B is an enlarged view of the adhesion part 314M shown in FIG. 15. FIG. 17 is a perspective view of the embodiment of hand part 311 shown in FIG. 15. In addition, FIGS. 15 to 17 are views of an embodiment where the hand part 311 is seen from the back side of FIG. 2. For this reason, compared to FIG. 2, the hand 311R and the hand 311L are reversed.

The adhesion part 314 shown in the drawings may include the adhesion part 314R1 or 314R2 and the adhesion part 314M.

As shown in FIG. 15, the adhesion part 314R1 or 314R2 may be positioned on the front end 311c of the hand 311R. As shown in FIG. 17, two adhesion parts 314 may be positioned on the front end 311c of the hand 311R. The two adhesion parts 314 are the adhesion part 314R1 and the adhesion part 314R2. The adhesion part 314R1 and the adhesion part 314R2 may be positioned in parallel to each other in a direction perpendicular to a direction in which the hand 311R is operated. A larger target object B may be secured more stably by using the two adhesion parts 314R1 and 314R2. In addition, a smaller target object B may be secured by using one of the adhesion part 314R1 and adhesion part 314R2.

In an embodiment, the adhesion part 314 may not be positioned on the hand 311L. In other words, the adhesion parts 314 may be positioned on the front end 311c of one of the pair of hands 311R and 311L. In this embodiment, the hand 311R may be the one of the pair of hands 311R and 311L. In other words, the adhesion parts 314 may not be positioned on the front end 311c of the other one of the pair of hands 311R and 311L. In this case, the hand 311L may be the other one of the pair of hands 311R and 311L. Through this configuration, it is possible to avoid the adhesion part 314 from being obstructed by the target object B. For example, the target object B may be a bowl placed on a table or the like, and one of the hands 311R and 311L may need to be slidably placed under the bowl to grip the bowl. A space between the table and the bowl may be narrow. Here, the adhesion part 314 may be obstructed in case of using the hand 311R, and the hand may thus be difficult to be slidably placed under the bowl. On the other hand, it may be easy for the hand to be slidably placed under the bowl in case of using the hand 311L that is not mounted with the adhesion part 314.

The adhesion parts 314R1 and 314R2 may be used to secure the target object B from the front end 311c of the hand 311R. The target object B to be secured may be, for example, tableware, food, a substrate, a board, paper or the like.

In addition, the adhesion part 314 positioned on the front end 311c of the hand 311R is not limited to this type. For example, the adhesion parts 314 may be positioned on both the hands 311R and 311L. Alternatively, one adhesion part 314 may be positioned on the hand 311R or 311L. Alternatively, as shown in FIG. 17, the plurality of adhesion parts 314 may be two adhesion parts or three or more adhesion parts.

The adhesion parts 314R1 and 314R2 may each have a structure as described below.

FIG. 16A is a view showing the structures of the adhesion parts 314R1 and 314R2. In addition, the adhesion part 314R1 and the adhesion part 314R2 may have the same structure. The drawings thus show the adhesion parts 314R1 and 314R2 as the adhesion part 314R1 or 314R2.

As shown in FIG. 16A, the adhesion part 314R1 or 314R2 may include an adhesion pad 314k1, an adhesion pump 314p1 and a waterproof filter 314f1. In addition, the adhesion part 314R1 or 314R2 may include an exhaust port for exhausting the suctioned air to the outside. As shown in FIG. 17, the exhaust port may include a waterproof filter 314f2.

The adhesion pad 314k1 may adhere to the target object B by the negative pressure generated by suctioning air.

The adhesion pump 314p1 may be an example of a pump that suctions air. The adhesion pump 314p1 may be, for example, a piezo pump. The robot hand may have improved silence by using the piezo pump.

The waterproof filter 314f1 may be an example of the first waterproof filter, and have a function of blocking water but allowing air to pass there through. The waterproof filter 314f1 may thus prevent water from entering the inside of the robot hand together with air even in case that air is suctioned by the adhesion pump 314p1.

The waterproof filter 314f2 may be an example of the second waterproof filter, and have a function of blocking water but allowing air to pass there through like the waterproof filter 314f1. The waterproof filter 314f2 may thus prevent water from entering the inside of the robot hand from the exhaust port.

As shown in FIG. 15, the adhesion part 314M may be positioned between the hand 311R and the hand 311L. In other words, this adhesion part 314M may be positioned between the pair of hands 311R and 311L. In detail, the adhesion part 314M may be positioned between the rear ends of the hands 311R and 311L. That is, the adhesion part 314M may be positioned adjacent to the joint parts 311d1 and 311d2, and positioned between the joint parts 311d1 and 311d2.

The adhesion part 314M may be used, for example, to adhere to a drawer in case of opening and closing the drawer. The adhesion part 314M may also be used, for example, to adhere to a cover in case of opening and closing the cover. The cover may be, for example, the manuscript cover or front cover of the copy device. In addition, the cover may be a lid of the washing machine. The adhesion part 314M may also be used to adhere to a door in case of opening and closing the door. The adhesion part 314M may be used in case that the hand 311R and the hand 311L are open widest in the first movement region. In other words, the hand 311R and the hand 311L may be developed in the first movement region. In the example of FIG. 2B, the hand 311R and the hand 311L may be moved to have an angle of a degrees. Accordingly, the hand 311R and the hand 311L may not be obstructed by the target object B in case that the adhesion part 314M adsorbs the target object B.

The adhesion part 314M may have a structure as described below.

FIG. 16B is a view showing the structure of the adhesion part 314M.

As shown in FIG. 16B, the adhesion part 314M may include an adhesion pad 314k2, an adhesion pump 314p2 and a waterproof filter 314f3. That is, the adhesion part 314M may have a structure similar to that of the adhesion part 314R1 or 314R2.

The adhesion pad 314k2 may adhere to a target object B by the negative pressure generated by suctioning air.

The adhesion pump 314p2 may be an example of the pump that suctions air. The adhesion pump 314p2 may also be, for example, a piezo pump.

The waterproof filter 314f3 may be an example of the first waterproof filter, and have the function of blocking water but allowing air to pass there through. It is thus possible to prevent water from entering the inside of the robot hand together with air even in case that air is suctioned by the adhesion pump 314p2.

In addition, the adhesion parts 314 in the example mentioned above may be three adhesion parts, i.e. the adhesion part 314R1, the adhesion part 314R2 and the adhesion part 314M. However, it is not necessary to have three adhesion parts, and at least one thereof may be sufficient as the adhesion part 314. That is, the adhesion part 314 may be positioned on one of the pair of hands 311L and 311R. Alternatively, the adhesion part 314 may be positioned on the other one of the pair of hands 311L and 311R. Alternatively, the adhesion part 314 may be positioned between the pair of hands 311L and 311R. The disclosure may use at least one of these three installation methods.

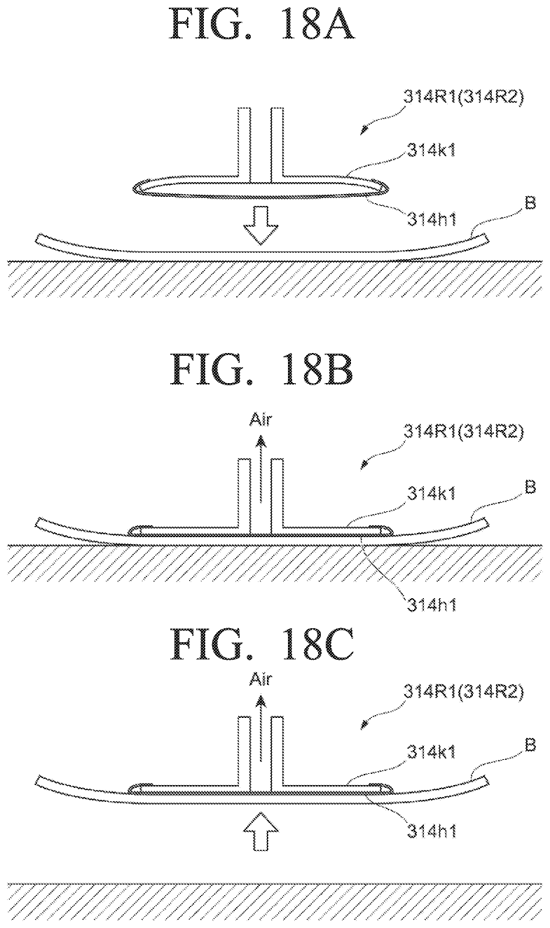

FIGS. 18A, 18B and 18C are views each showing an operation of the adhesion part 314.

In addition, the description is provided by exemplifying an operation of the adhesion part 314R1 or 314R2, and the same description may also be provided for an operation of the adhesion part 314M. In addition, the description here describes a case where a thin film 314h1 is further added to the structure described with reference to FIG. 16.

The thin film 314h1 may be an example of a film. The thin film 314h1 may prevent dirt from adhering to the adhesion pad 314k1 or the waterproof filter 314f1. That is, dirt may adhere to the adhesion pad 314k1 or the waterproof filter 314f1 in when the adhesion part adsorbs tableware or the like soiled with oil. In this case, the adhesion part 314R1 or 314R2 may have reduced adhesion performance. In addition, the robot hand may have difficulty cleaning dishes or the like if dirt adheres to adhesion pad 314k1. Accordingly, the robot hand may include the thin film 314h1 to prevent dirt from adhering to the adhesion pad 314k1 or the waterproof filter 314f1. In this case, the thin film 314h1 may entirely cover the adhesion pad 314k1.

FIG. 18A shows a state of the adhesion part 314R1 or 314R2 before adhering to a target object B. In the state of FIG. 18A, the adhesion pump 314p1 may not be operated and thus, air may not be suctioned by the pump. In this state, a space may exist between the adhesion pad 314k1 and the thin film 314h1. Air may exist in this space, and its atmospheric pressure may be the same as atmospheric pressure of air around the target object B.

FIG. 18B shows a state of the adhesion part 314R1 or 314R2 in case of adhering to target object B. In the state of FIG. 18B, the adhesion pump 314p1 may be operated and thus, air may be suctioned by the pump. It is thus possible to suction air existing in the space between the adhesion pad 314k1 and the thin film 314h1. In addition, the adhesion pad 314k1 and the thin film 314h1 may be deformed to make this space smaller. As a result, the negative pressure may be generated, and the target object B may be adhered to by the adhesion pad 314k1.

FIG. 18C shows a state of the adhesion part 314R1 or 314R2 in case of moving the target object B. In the state of FIG. 18B, the adhesion pump 314p1 may be operated and thus, air may be suctioned by the pump. The negative pressure generated in FIG. 18B may thus be maintained, and the target object B may be moved while being adhered to by the adhesion pad 314k1.

In an alternative embodiment, the thin film 314h1 may not necessarily need to be provided. In another alternative embodiment, the thin film 314h1 may partially cover the adhesion pad 314k1 (although FIG. 18 shows that the thin film 314h1 entirely covers the adhesion pad 314k1). That is, the thin film 314h1 may cover at least a portion of the adhesion pad 314k1.

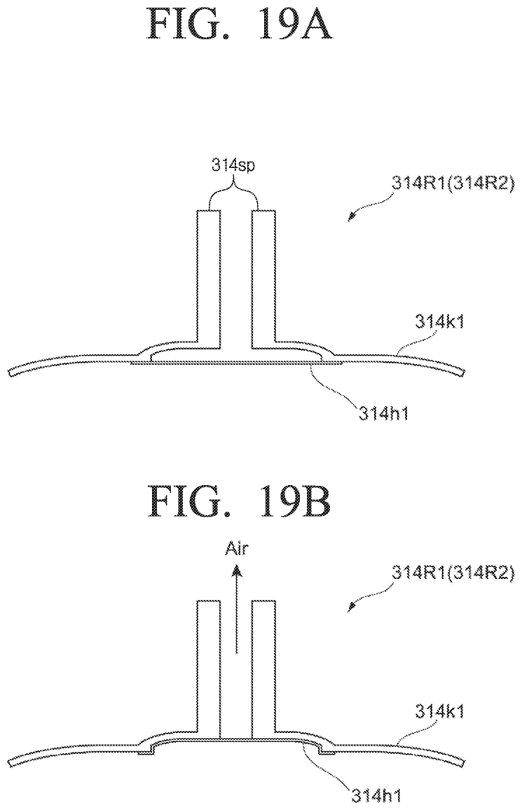

FIGS. 19A and 19B are views each showing an embodiment where the thin film 314h1 partially covers the adhesion pad 314k1.

FIG. 19A shows a state of the adhesion part 314R1 or 314R2 before adhering to the target object B. In the state of FIG. 19A, the adhesion pump 314p1 may not be operated and thus, air is not suctioned by the pump. This state is the same as the state of FIG. 18A.

FIG. 19B shows a state of the adhesion part 314R1 or 314R2 in case of adhering to the target object B. In the state of FIG. 19B, the adhesion pump 314p1 may be operated and thus, air may be suctioned by the pump. Air existing in a space between the adhesion pad 314k1 and the thin film 314h1 may thus be suctioned. In addition, the thin film 314h1 may be deformed to make this space smaller. As a result, the negative pressure may be generated, and the target object B may be adhered to by the adhesion pad 314k1.

In this way, the adhesion part 314 may include a mechanism for preventing the target object B from sliding off That is, the adhesion pads 314k1 and 314k2 or the adhesion pumps 314p1 and 314p2 may be positioned on the front ends 311c. The adhesion pad 314k1 or 314k2 may adhere to the target object B by the negative pressure generated by the adhesion pump 314p1 or 314p2. This mechanism may prevent the target object B from sliding off.

Additionally or alternatively, a pressing mechanism 314sp such as a spring may be positioned on a surface of the adhesion pad 314k1 or 314k2, opposite to its surface on which the adhesion pad adheres to the target object B. That is, the pressing mechanism 314sp such as a spring may be positioned at the rear of the adhesion pad 314k1 or 314k2, and press the adhesion pad 314k1 or 314k2 against the target object B. Here, a direction of the adhesion pump 314p1 or 314p2 may be changed by the pressing mechanism 314sp. In this case, even if there are irregularities on a surface of a target object B, the direction of the adhesion pad 314k1 or 314k2 may be changed based on a shape of the irregularities. That is, a posture of the adhesion pad 314k1 or 314k2 may be changed based on the shape of the surface of the target object B. The target object B may be more difficult to slip off by such a pressing mechanism.

Next, control of the robot 1 is described in more detail. The robot 1 may be controlled by the control device 20.

Hereinafter, the description describes a method for controlling the robot 1 by the control device 20.

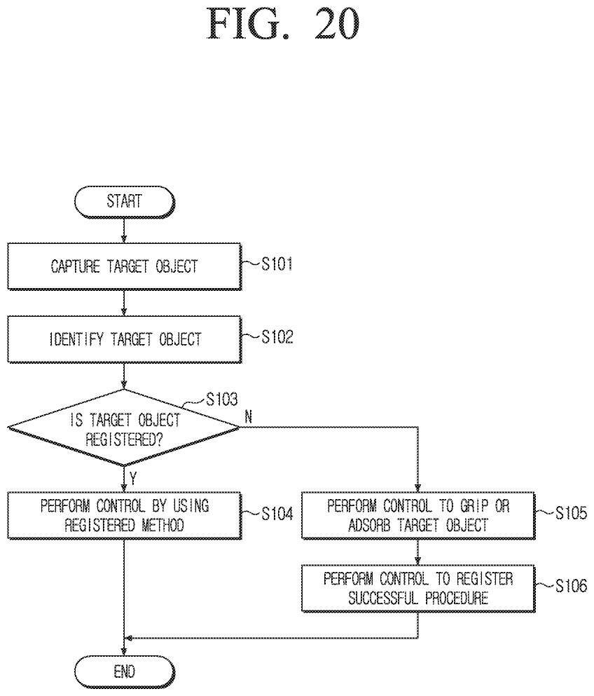

FIG. 20 is a flowchart of a method for controlling the robot 1 according to an embodiment.

First, the imaging device 10 may capture the target object B (Step 101). An image of the target object B captured by the imaging device 10 may be transmitted to the control device 20.

Next, the control device 20 may identify the target object B (Step 102). The control device 20 may identify the target object B by using a conventional method. For example, the control device 20 may determine the shape, spatial position and direction of the target object B. The control device 20 may then identify the target object B by matching the target object B with a pre-registered target object.

The control device 20 may then determine whether the identified target object B is registered (Step 103).

As a result, the control device 20 may perform the following control in case that the target object B is the registered target object (“Yes” in Step 103). That is, the control device 20 may control at least one of gripping or adhering to the target object B by using a method registered for the registered target object (Step 104). That is, a certain method determined in advance is used to perform the gripping or adsorbing of the registered target object. In addition, the control device 20 may control the registered target object B to be gripped or adhered to by the predetermined method. In this case, the control device 20 may also perform control to perform either one of the gripping and the adhering to of the target object B or a combination of both the gripping and the adhering to of the target object B.

The control device 20 may control the opening and closing of the hand part 311 of the robot hand 31 in case that the registered target object B is gripped. In addition, the control device 20 may also control the arm 32 to match the position or direction of the robot hand 31. The registered target object B may be gripped by the hand part 311 by this control.

In addition, the control device 20 may control the opening and closing of the hand part 311 of the robot hand 31 in case that the registered target object is adhered to. In addition, the control device 20 may control the adhesion part 34. In detail, the control device 20 may control an operation of the adhesion pump 314p1 or 314p2 of the adhesion part 34. In addition, the control device 20 may also control the arm 32 to match the position or direction of the robot hand 31. The control device 20 may thus control the adhesion pad 314k1 or 314k2 to adhere to the registered target object. The registered target object B may be adhered to the adhesion part 314M by this control.

On the other hand, the control device 20 may perform the following control in case that the target object B is an unregistered target object (“No” in Step 103). That is, the control device 20 may control at least one of gripping or adhering to the unregistered target object B (Step 105). In addition, in this case, it is possible to perform either one of the gripping and the adhering or a combination of both the gripping and the adhering. That is, without determining a certain method in advance, a method is selected to perform the gripping or adhering to of the unregistered target object B. The control device 20 may thus control whether it is able to perform the gripping or adhering to of the unregistered target object B. The control device 20 may determine whether to grip and/or adhere to unregistered target object B based on the size, direction, shape or the like of the unregistered target object B in case that the target object is gripped or adhered to. In addition, the control device 20 may determine a posture of the hand part 311 based on the size, direction, shape or the like of the unregistered target object B. In addition, the control device 20 may control the attempt to be repeated using another method in the event that the gripping or adhering to of the target object B fails. That is, the control device 20 may control the attempt to be repeated.

The control device 20 may perform control to register a successful procedure after the attempts (Step 106). That is, the control device 20 may perform the control to register at least one method in which the unregistered target object B is successfully gripped and adhered to in association with the unregistered target object B. For this reason, the unregistered target object B may thus be treated as a registered target object B.

According to the embodiments described in detail above, the driving force of the motor 322 may be used for the detachment of the robot hand 31. Therefore, another actuator or the like may not be required for the detachment of the robot hand 31. That is, the disclosure may provide the robot hand which may be detached using a simpler mechanism. The disclosure may also provide the robot including the robot hand. The disclosure may also provide the robot hand 31 having a less number of parts, and easily provide the robot hand 31 made smaller and lighter. The disclosure may also provide the robot hand 31 easily produced at a lower cost.

What is claimed is:

1. A robot hand comprising:
a gripping part configured to grip a target object; and
a mounting part configured to mount the gripping part to a mounted part of a robot,
wherein the gripping part is further configured to operate in a first movement region to grip the target object, and a second movement region to be removed from the mounted part, and
wherein the mounting part is engaged with the mounted part in the first movement region, and the mounting part is removed from the mounted part in the second movement region.

2. The robot hand of claim 1, wherein the mounting part comprises a slide part configured to slide in conjunction with an operation of the gripping part, and
wherein the mounting part is engaged with the mounted part by engaging the slide part to the mounted part in the first movement region as the slide part slides, and the mounting part is removed from the mounted part by disengaging the slide part from the mounted part in the second movement region.

3. The robot hand of claim 2, wherein the mounting part comprises a cam configured to rotate in conjunction with the operation of the gripping part, and
wherein the slide part slides by a force transmitted to the slide part by the cam.

4. The robot hand of claim 2, wherein the mounting part comprises a link part that is connected to the slide part,
wherein the slide part is configured to be operated in conjunction with the operation of the gripping part, and
wherein the slide part simultaneously slides by a force transmitted through the link part.

5. The robot hand of claim 1, further comprising a waterproof cover that covers an exterior of the robot hand.

6. The robot hand of claim 5, wherein the gripping part comprises a joint part and a non-joint part, and
wherein the waterproof cover comprises a first cover that covers the joint part, and a second cover that covers the non-joint part.

7. The robot hand of claim 6, further comprising a packaging part configured to waterproof seal a boundary between the first cover and the second cover.

8. The robot hand of claim 6, wherein the second cover is operable to be deformed when the joint part moves.

9. The robot hand of claim 5, further comprising a transmission part that comprises a magnetic coupling mechanism, and
wherein the transmission part is configured to:
transmit a driving force of a motor to the gripping part through the magnetic coupling mechanism, and
disengage the gripping part from the mounted part by causing the gripping part to operate in the second movement region.

10. The robot hand of claim 9, wherein the magnetic coupling mechanism comprises a first magnetic rotation part and a second magnetic rotation part,
wherein the magnetic coupling mechanism is configured to transmit the driving force of the motor by connecting the first magnetic rotation part provided on the mounted part with the second magnetic rotation part provided on the transmission part, and
wherein the waterproof cover is provided between the first magnetic rotation part and the second magnetic rotation part.

11. The robot hand of claim 1, further comprising an adhesion part configured to adhere to the target object.

12. The robot hand of claim 11, wherein the gripping part comprises a pair of hands, and wherein the adhesion part is provided on at least one of: one hand of the pair of hands and a portion of the gripping part located between the pair of hands.

13. The robot hand of claim 12, wherein the adhesion part is provided on a front end of one hand of the pair of hands, and
wherein a front end of the other hand of the pair of hands does not include an adhesion part.

14. The robot hand of claim 13, wherein a plurality of adhesion parts are provided on the front end of the one hand of the pair of hands.

15. The robot hand of claim 11, wherein the adhesion part comprises:
an adhesion pad configured to adhere to the target object;
a pump configured to suction air into the robot hand, and
a first waterproof filter configured to filter water from the air suctioned into the robot hand by the pump.

16. The robot hand of claim 15, wherein the adhesion part comprises an exhaust port,
wherein the exhaust port comprises a second waterproof filter, and
wherein the exhaust port is configured to exhaust the air suctioned into the robot hand by the pump and prevent water from entering the inside of the robot hand through the exhaust port.

17. The robot hand of claim 15, further comprising a film covering at least a portion of the adhesion pad.

18. The robot hand of claim 15, further comprising a pressing mechanism provided on a surface of the adhesion pad, opposite to the surface on which the adhesion pad adheres to the target object, and configured to press the adhesion pad.

19. A robot comprising:
a gripping part configured to grip a target object;
a mounted part; and
a mounting part configured to mount the gripping part to the mounted part,
wherein the gripping part is configured to operate in a first movement region to grip the target object, and a second movement region to be removed from the mounted part, and
wherein the mounting part is engaged with the mounted part in the first movement region, and the mounting part is removed from the mounted part in the second movement region.

20. A robot comprising:
a gripping part configured to grip a target object;
a mounted part configured to mount the gripping part thereto;
a motor configured to drive the gripping part; and
a controller configured to control the motor,
wherein the gripping part is further configured operate in a first movement region and a second movement region, and
wherein the controller is further configured to control the gripping part to operate in the first movement region to grip the target object and operate in the second movement region to be removed from the mounted part.

21. The robot of claim 20, further comprising an adhesion part,
wherein the controller is further configured to further control the adhesion part to adhere to the target object.

22. The robot of claim 21, wherein the controller is further configured to simultaneously control the gripping part to grip the target object and control the adhesion part to adhere to the target object.

23. The robot of claim 22, further comprising an imaging device,
wherein the controller is further configured to:
obtain an image of the target object using the imaging device,
identify whether the target object is a registered target object or an unregistered target object based on the image, and
based on identifying the target object is the registered target object, control at least one of gripping the target object by the gripping part using a method registered for the target object, or adhering to the target object by the adhesion part using a method registered for the target object.

24. The robot of claim 23, wherein the controller is further configured to, based on identifying the target object is the unregistered target object, control at least one of gripping the target object by the gripping part, adhering to the target object by the adhesion part, or registering at least one method in which the unregistered target object is successfully gripped or adhered.

25. The robot of claim 21, wherein the gripping part comprises a pair of hands, and
wherein the adhesion part is provided on at least one of one hand of the pair of hands or a portion of the gripping part located between the pair of hands.

26. The robot of claim 21, wherein the adhesion part comprises:
an adhesion pad configured to adhere to the target object;
a pump configured to suction air into the robot; and
a first waterproof filter configured to filter water from the air suctioned into the robot by the pump, and
wherein the controller is further configured to control the adhesion pad to adhere to the target object by controlling an operation of the pump.
